(19) United States
(12) Patent Application Publication
(10) Pub. No.: US 2014/0232754 A1
(43) Pub. Date: Aug. 21, 2014

(54) INDICATING AN EDGE OF AN ELECTRONIC DOCUMENT

(71) Applicant: Phoenix Technologies Ltd., (US)

(72) Inventor: Jack Wang, Milpitas, CA (US)

(21) Appl. No.: 13/888,078

(22) Filed: May 6, 2013

(30) Foreign Application Priority Data
Feb. 20, 2013 (TW) 102105893

(51) Int. Cl. G09G 5/34; G09G 5/00

(52) U.S. Cl. CPC G09G 5/34; G09G 5/00
USPC 345/684; 345/682

(57) ABSTRACT

A first portion of the electronic document is displayed without displaying the entire electronic document. Upon receiving input, the appearance of the electronic document is updated by displaying a second portion of the electronic document which is different than the first portion. An appearance of a third portion of the electronic document is dynamically updated or a message is dynamically generated when an edge of the electronic document is reached. The third portion of the electronic document is located between the edge and a position indicating point. In this way, the user may be informed when an edge of the electronic document is reached.

### CLAIM OF PRIORITY

This patent application claims priority to Taiwanese patent application 102105893, filed Feb. 20, 2013, entitled “Method for Indicating an Edge of an Electronic Document,” invented by Jack Wang, the contents of which are hereby incorporated by reference in their entity for all purposes as if fully set forth herein.

### FIELD OF THE INVENTION

The present invention relates to approaches for visually informing a user that an edge or a boundary of an electronic document has been reached.

### BACKGROUND

Due to the dimensions of the viewing area of a display depicting an electronic document, the full content of the electronic document in its entirety may not be completely viewable on the display. Certain user interfaces allow a user to move the electronic document on the display in order to view other portions of the electronic document. For example, the user interface may allow the user to perform a scroll operation on the electronic document to display different portions of the electronic document. However, once an edge of the electronic document is reached, the user may not be aware of that fact using traditional approaches. As a result, the user may keep moving the electronic document on the display without realizing the edge of the electronic document in that direction has been reached. Therefore, it is desirable to provide approaches for identifying an edge or boundary of an electronic document to the user when only a portion of the electronic documents is displayed.

### SUMMARY

In accordance with an embodiment of the present invention, a method is implemented by an electronic device having a display. The method comprises displaying a first portion of an electronic document that includes at least two edges. User input requesting movement of the electronic document in a particular direction is received. Such movement may be requested to display a new portion of the electronic document. A second portion (the “newly displayed portion”) of the electronic document is displayed in response to the user input. The second portion is different from the first portion. Thereafter, a third portion (the “visual cue portion”) of the electronic document is dynamically changed and/or a message is generated when an edge of the electronic document is reached. The third portion is located between the edge and a position indicating point. The edge corresponds to a first edge and/or a second edge that is opposite to the first edge. A fourth portion, which is different from the first portion, of the electronic document, is displayed. Such an embodiment may be implemented upon an electronic device that comprises a display device, at least one processor, a memory and at least one program.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 shows a schematic view of a method implemented by an electronic device of one embodiment of present invention;

FIG. 2A shows a schematic view of dynamically changing the third portion of the electronic document according to an embodiment of the present invention;

FIG. 2B shows a schematic view of dynamically changing the third portion of the electronic document according to an embodiment of the present invention;

FIG. 3 shows a schematic view of dynamically changing the third portion of the electronic document according to an embodiment of the present invention;

FIG. 4A shows a schematic view of dynamically changing the third portion of the electronic document according to an embodiment of the present invention;

FIG. 4B shows a schematic view of dynamically changing the third portion of the electronic document according to an embodiment of the present invention;

FIG. 5 shows a schematic view of dynamically changing the third portion of the electronic document according to an embodiment of the present invention;

FIG. 6 shows a schematic view of dynamically changing the third portion of the electronic document according to an embodiment of the present invention;

FIG. 7A shows a schematic view of dynamically changing the third portion of the electronic document according to an embodiment of the present invention;

FIG. 7B shows a schematic view of dynamically changing the third portion of the electronic document according to an embodiment of the present invention;

FIG. 8A shows a schematic view of dynamically changing the third portion of the electronic document according to an embodiment of the present invention;

FIG. 8B shows a schematic view of dynamically changing the third portion of the electronic document according to an embodiment of the present invention;

FIG. 9 shows a schematic view of dynamically changing the third portion of the electronic document according to an embodiment of the present invention;

FIG. 10 shows a schematic view of a flow chart of a method implemented by an electronic device of one embodiment of the present invention; and

FIG. 11 shows a schematic view of an electronic device of one embodiment of the present invention.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to an electronic device including a display to indicate an edge of an electronic document. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

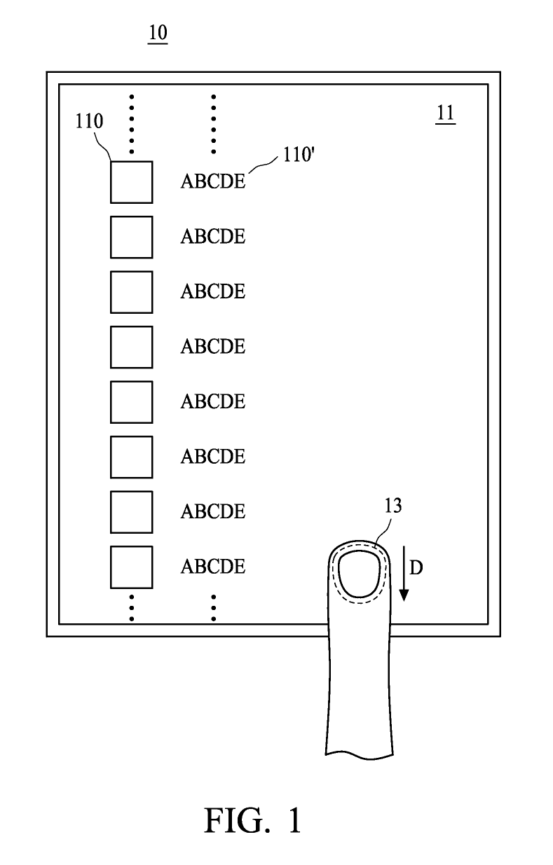

FIG. 1 shows a schematic view of a method implemented by an electronic device of one embodiment of present invention.

As shown in FIG. 1, the electronic device 10 includes a display. In the current embodiment, the display comprises a touch screen display 11. A first portion of an electronic document is displayed on the touch screen display. The electronic document includes at least two edges. In the current embodiment, the electronic document may include at least one icon 110 and at least one font 110′.

When a user would like to view a second portion of the electronic document, the user may use a finger or a stylus to move the electronic document on the touch screen 11 in a direction D. In the current embodiment, the second portion is different from the first portion.

Moreover, in the current embodiment, but not limited to such, the direction D may comprise a vertical direction along the touch screen display 11. In another embodiment, the direction D may comprise a horizontal direction along the touch screen display 11. In another embodiment, the direction D may comprise a direction an oblique direction of the touch screen display 11.

When the user keeps moving the finger or the stylus, in the direction D on the touch screen display 11, a movement in the direction D would be continuously detected by software displaying the electronic document, and the portion of the electronic document being displayed would continuously move in response to the movement until an edge of the electronic document is reached.

When the edge of the electronic document is reached, a third portion of the electronic document may be dynamically changed and/or a message may be generated to inform the user that the edge of the electronic document is reached. The edge of the electronic document that is reached may comprise or correspond to a first edge and/or a second edge opposite to the first edge. The third portion is located between the first edge and/or the second edge and a position indicating point 13. The position indicating point 13 may correspond to the finger touching point on the touch screen display 11 or the stylus touching point on the touch screen display 11. The message may be implemented by vibration and/or a sound generated or produced by the electronic device.

In one embodiment of the present invention, the display comprises a non-touch screen display. Therefore, in the current embodiment, the position indicating point 13 comprises a position of a mouse cursor or a projection point of a pointing device on the non-touch screen display.

Moreover, a fourth portion of the electronic document may be displayed on the touch screen display after the third portion of the electronic document had been dynamically changed. The fourth portion is different from the first portion.

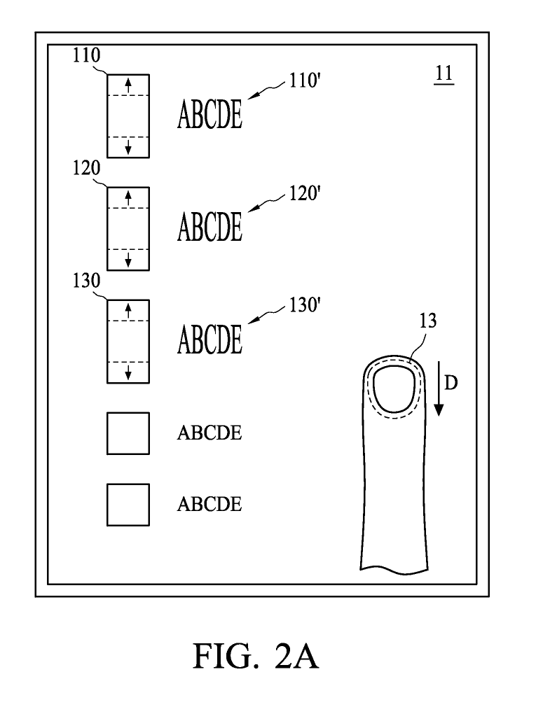

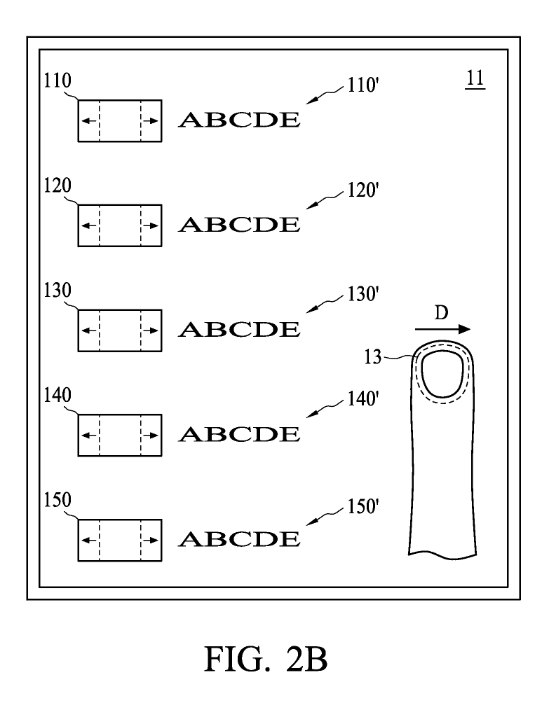

FIG. 2A shows a schematic view of dynamically changing the third portion of the electronic document.

As shown in FIG. 2A, at least one icon and/or at least one font of the third portion of the electronic document may be extended in at least one direction to inform the user that the first edge of the electronic document is reached. In the current embodiment, the third portion is located between the position indicating point 13 and the first edge. The icons 110, 120 and 130, and the fonts 110′, 120′ and 130′ are extended in a vertical direction along the touch screen display 11 but are not limited to such. Moreover, in the current embodiment, the first edge is an upper edge of the electronic document but is not limited to such.

FIG. 2B shows a schematic view of dynamically changing the third portion of the electronic document.

In another embodiment of present invention, as shown in FIG. 2B, at least one icon and/or at least one font may be extended in at least one direction to inform the user that the first edge of the electronic document is reached. In the current embodiment, the third portion is located between the position indicating point 13 and the first edge. The icons 110, 120, 130, 140, and 150, and the fonts 110′, 120′, 130′, 140′ and 150′ are extended in a horizontal direction along the touch screen display 11 but are not limited to such. Moreover, in the current embodiment, the first edge is a left edge of the electronic document but is not limited to such.

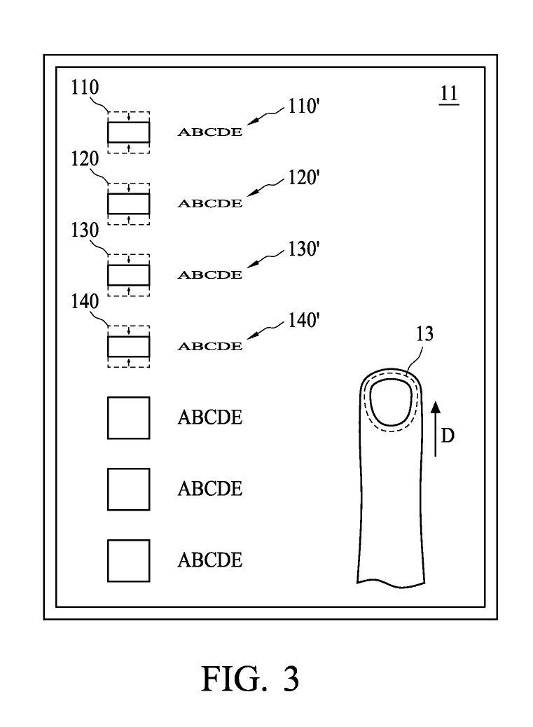

FIG. 3 shows a schematic view of dynamically changing the third portion of the electronic document.

As shown in FIG. 3, at least one icon and/or at least one font of the third portion of the electronic document may be shrunk or reduced in size to visually inform the user that a second edge of the electronic document has been reached. In the current embodiment, the third portion is located between the position indicating point 13 and the first edge. The icons 110, 120, 130 and 140 and the fonts 110′, 120′, 130′ and 140′ are shrunk or reduced in size in a vertical direction along the touch screen display 11 but are not limited to such. Moreover, in the current embodiment, the second edge is a lower edge of the electronic document.

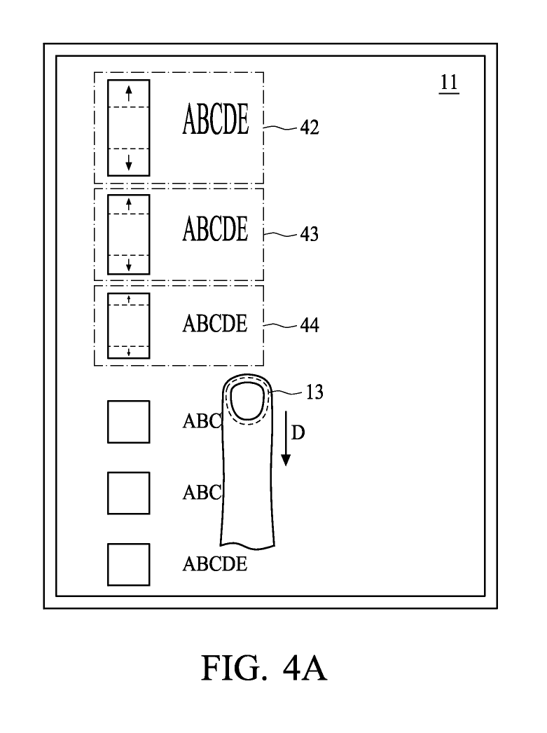

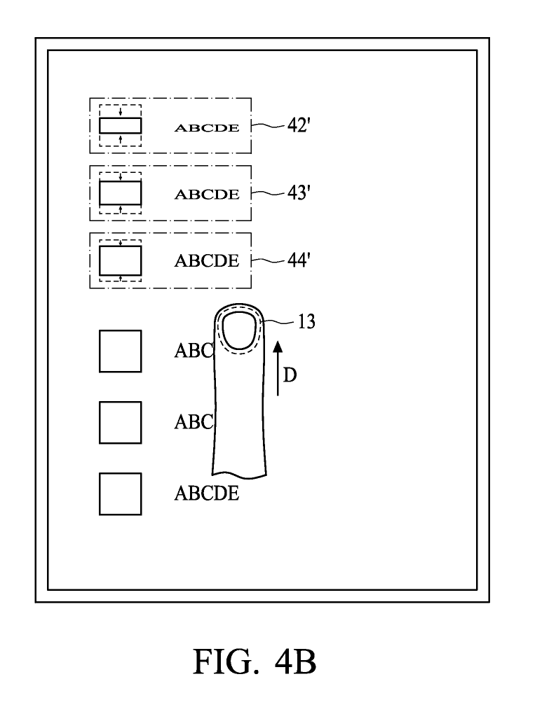

FIG. 4A shows a schematic view of dynamically changing the third portion of the electronic document.

As shown in FIG. 4A, at least one icon and/or at least one font of the third portion of the electronic document may be extended in a different extension manner, in at least one direction, to inform the user that the first edge of the electronic document is reached. The third portion is located between the position indicating point 13 and the first edge. In the current embodiment, the icons and/or the fonts 42, 43 and 44 are extended in a different extension manner. The icons and/or the fonts 42, 43 and 44 are also extended in a vertical direction along the touch screen display 11 but are not limited to such. For example, a vertical distance of the icon and/or font 42 is longer than a vertical distance of the icon and/or font 43. The vertical distance of the icon and/or font 43 is longer than a vertical distance of the icon and/or font 44. Moreover, in the current embodiment, the first edge is an upper edge of the electronic document.

FIG. 4B shows a schematic view of dynamically changing the third portion of the electronic document.

As shown in FIG. 4B, at least one icon and/or at least one font of the third portion of the electronic document may be extended in a different extension manner, in at least one direction, to inform the user that the second edge of the electronic document is reached. The third portion is located between the position indicating point 13 and the first edge. In the current embodiment, each height of the icons and/or the fonts 42′, 43′ and 44′ is decreased respectively in a different decreasing manner. For example, a height of the icon and/or font 42′ is shorter than a height of the icon and/or font 43′. The height of the icon and/or font 43′ is shorter than a height of the icon and/or font 44′. In the current embodiment, the second edge is a lower edge of the electronic document.

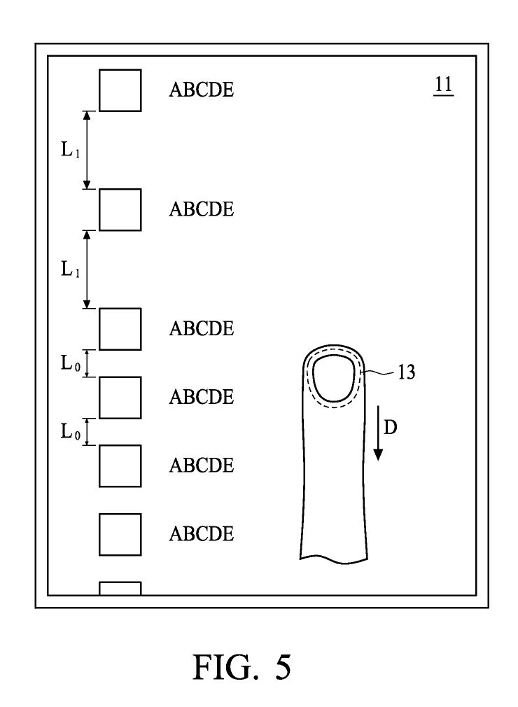

FIG. 5 shows a schematic view of dynamically changing the third portion of the electronic document.

As shown in FIG. 5, each spacing between the icons and/or each spacing between the fonts of the third portion of the electronic document may be dynamically enlarged from L₀ to L₁ to inform the user that the first edge of the electronic document is reached, where the spacing L₀ is an unchanged spacing. Moreover, in the current embodiment, the first edge comprises an upper edge of the electronic document.

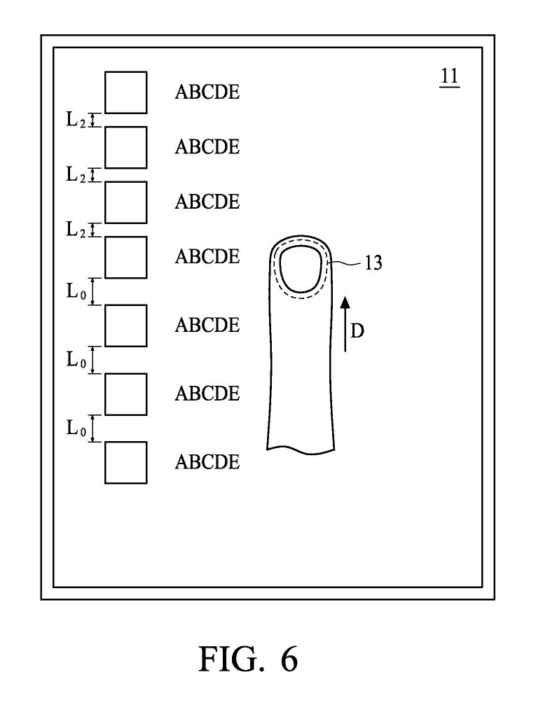

FIG. 6 shows a schematic view of dynamically changing the third portion of the electronic document.

As shown in FIG. 6, spacing between the icons and/or spacing between the fonts of the third portion of the electronic document may be dynamically reduced from L₀ to L₂ for informing the user that the second edge of the electronic document is reached, where the spacing L₀ is an unchanged spacing. Moreover, in the current embodiment, the second edge comprises a lower edge of the electronic document. The embodiments shown in FIG. 5 and FIG. 6 are equally dynamically changing the spacing between icons and/or fonts.

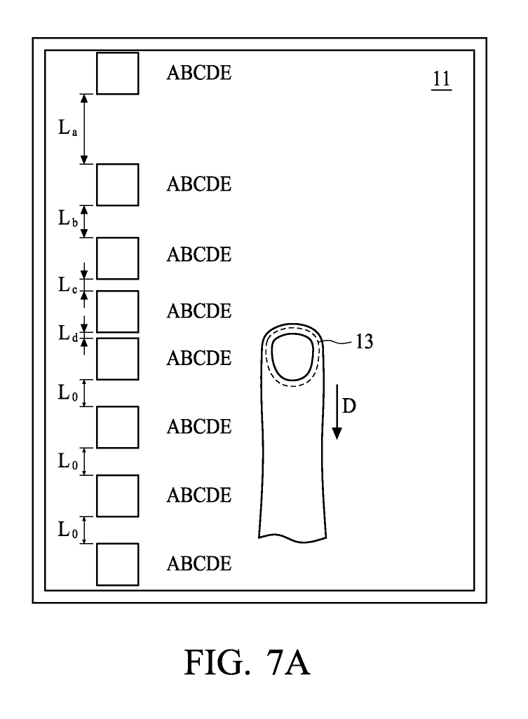

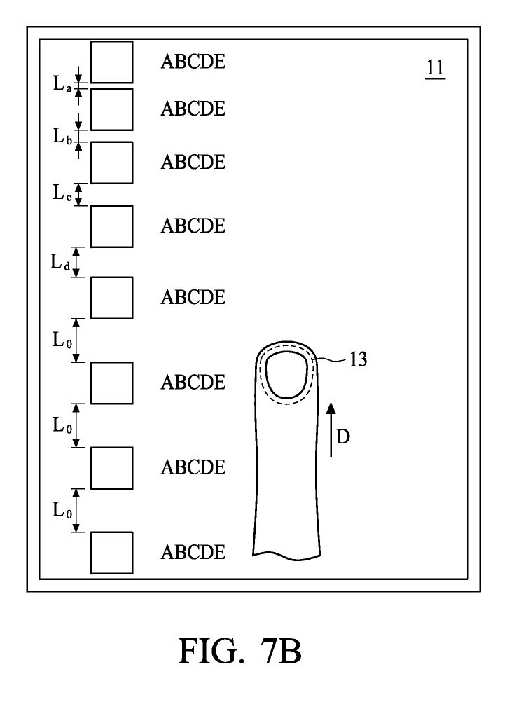

FIG. 7A shows a schematic view of dynamically changing the third portion of the electronic document.

As shown in FIG. 7A, each spacing between the icons and/or each spacing between the fonts of the third portion of the electronic document may be respectively dynamically changed from L₀ to Lₐ, L₀ to L_{b}, L₀ to L_{c} and L₀ to L_{d} for the purpose of informing the user that the first edge of the electronic document is reached, wherein the spacing L₀ is an unchanged spacing. In the current embodiment, the first edge comprises an upper edge of the electronic document. As shown in FIG. 7A, the spacing Lₐ is bigger than the spacing L_{b}, the spacing L_{b} is bigger than the spacing L_{c}, and the spacing L_{c} is bigger than the spacing L_{d}.

FIG. 7B shows a schematic view of dynamically changing the third portion of the electronic document.

As shown in FIG. 7B, each spacing between the icons and/or each spacing between the fonts of the third portion of the electronic document may be respectively dynamically changed from L₀ to Lₐ, L₀ to L_{b}, L₀ to L_{c} and L₀ to L_{d} for the purpose of informing the user that the second edge of the electronic document is reached, where the spacing L₀ is an unchanged spacing. In the current embodiment, the second edge comprises a lower edge of the electronic document. As shown in FIG. 7B, the spacing Lₐ is smaller than the spacing L_{b}, the spacing L_{b} is smaller than the spacing Lc, and the spacing L_{c} is smaller than the spacing L_{d}.

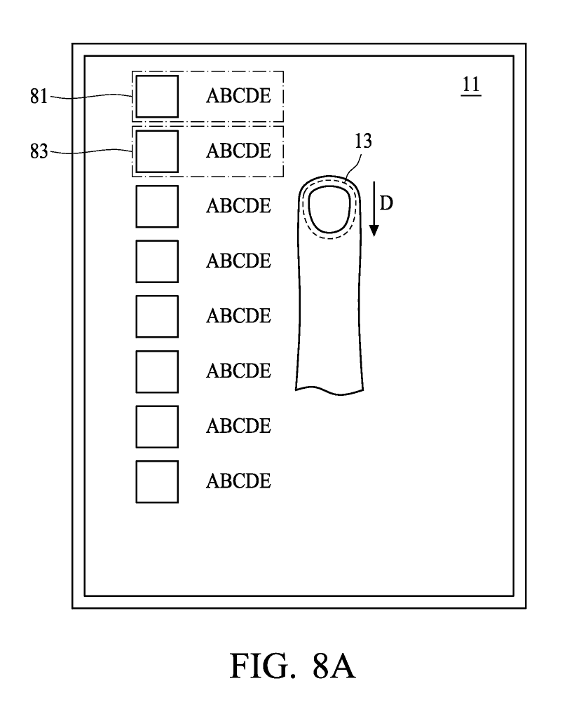

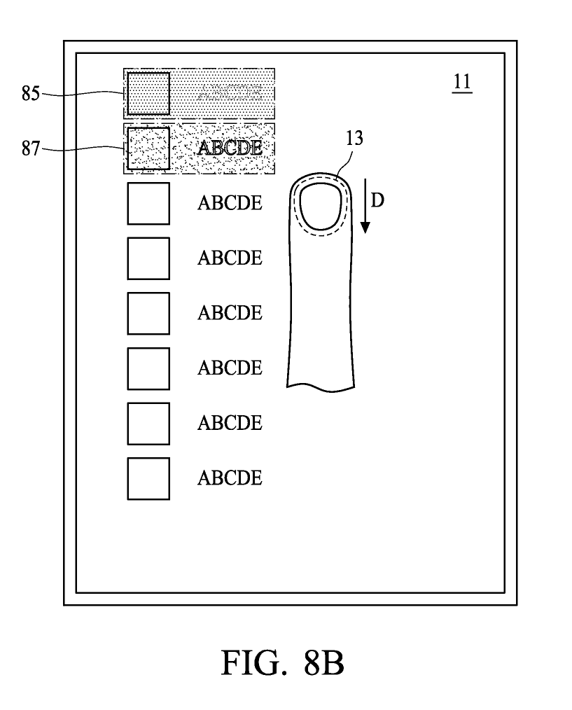

FIG. 8A shows a schematic view of dynamically changing the third portion of the electronic document.

As shown in FIG. 8A, at least one icon and/or at least one font 81 and 83 of the third portion of the electronic document may be displayed flashing to inform the user that the first edge of the electronic document is reached. The third portion is located between the position indicating point 13 and the first edge. In the current embodiment, the first edge is an upper edge of the electronic document but is not limited in other embodiments of the present invention.

FIG. 8B shows a schematic view of dynamically changing the third portion of the electronic document.

As shown in FIG. 8B, colors of at least one icon and/or at least one font 85 and 87 of the third portion of the electronic document may be changed to inform the user that the first edge of the electronic document is reached. The third portion is located between the position indicating point 13 and the first edge. In the current embodiment, the first edge is an upper edge of the electronic document but is not limited in other embodiments of the present invention.

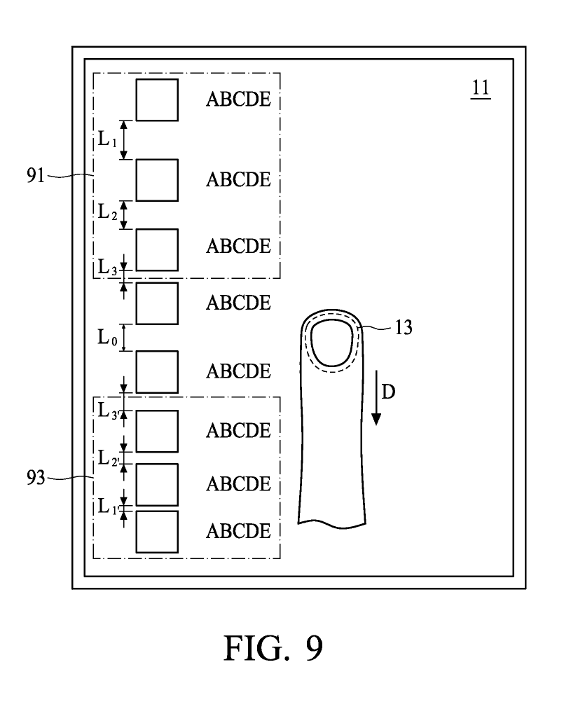

FIG. 9 shows a schematic view of dynamically changing the third portion of the electronic document.

As shown in FIG. 9, the step of dynamically changing comprises changing the icons and/or the fonts 91 and the icons and/or the fonts 93. The icons and/or the fonts 91 are located between the position indicating point 13 and an upper edge. The icons and/or the fonts 93 are located between the position indicating point 13 and a lower edge. Moreover, as shown in FIG. 9, spacing between the icons and/or spacing between the fonts 91 are changed from L₀ to L₁, L₀ to L₂ and L₀ to L₃, where the spacing L₁ is bigger than the spacing L₂, and the spacing L₂ is bigger than spacing L₃. Spacing between the icons and/or spacing between the fonts 93 are changed from L₀ to L₁′, L₀ to L₂′ and L₀ to L₃′, where the spacing L_{1′} is smaller than the spacing L₂′, and the spacing L₂′ is bigger than the spacing L₃′.

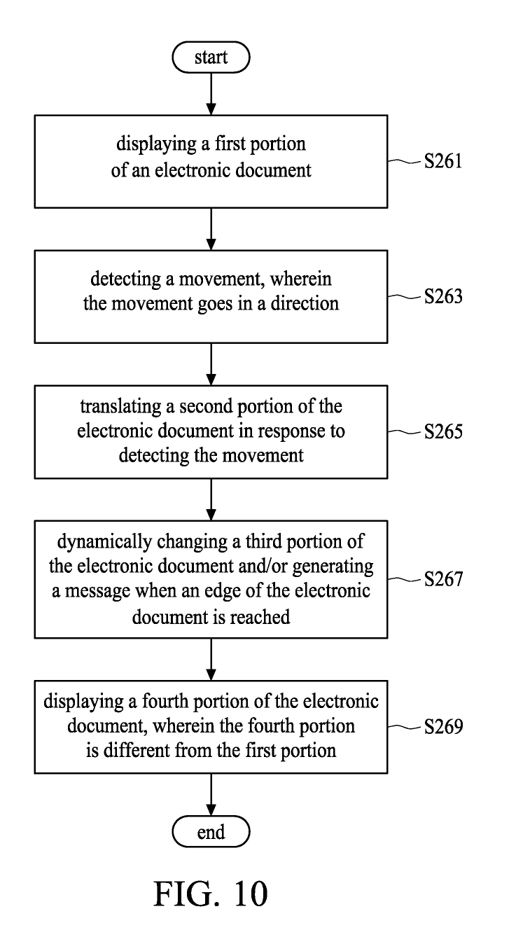

FIG. 10 shows a schematic view of a flow chart of a method implemented by an electronic device of one embodiment of the present invention.

As shown in FIG. 10, in step S261, a first portion of an electronic document is presented on a display of the electronic device, wherein the electronic document comprises at least two edges. In step S263, a movement that goes in a direction that is detected. This movement may be, in one embodiment, a scroll operation issued by the user to scroll the electronic document in the detected direction. In step S265, a second portion of the electronic document is translated in response to the movement, wherein the second portion is different from the first portion. In step S267, a third portion of the electronic document may be dynamically changed and/or a message may be generated when an edge of the electronic document is reached, where the edge comprises a first edge and/or a second edge opposite to the first edge. The third portion may be located between the first edge and/or the second edge and a position indicating point. In step S269, a fourth portion of the electronic document may be presented on the display, where the fourth portion is different from the first portion. In an embodiment, the steps of FIG. 10 may be implemented by software executing on a device having a display capable of displaying the electronic document.

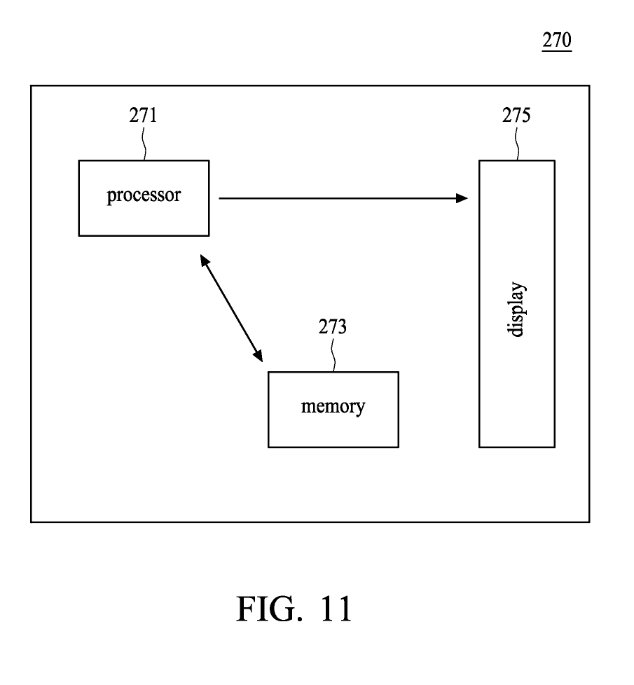

FIG. 11 shows a schematic view of an electronic device of one embodiment of the present invention.

As shown in FIG. 11, the electronic device 270 comprises a display 275, at least one processor, a memory 273 and at least one program. The display 275 is configured to display an electronic document, where the electronic document comprises at least two edges. The program is configured to be stored in the memory and executed by the processor.

Moreover, the program comprises at least one instruction configured to display a first portion of an electronic document; at least one instruction configured to detect a movement going in a direction; at least one instruction configured to translate a second portion of the electronic document, where the second portion is different from the first portion; at least one instruction configured to dynamically change a third portion of the electronic document and/or generate a message when an edge of the electronic document is reached, where the edge comprises a first edge and/or a second edge, where the first edge is opposite to the second edge, and where the third portion is located between the first edge and/or the second edge and a position indicating point; at least one instruction configured to stop the step of dynamically changing a third portion of the electronic document and/or generating a message when the movement going in the direction is not detected; and at least one instruction configured to display a fourth portion of the electronic document after the at least one instruction configured to stop the step of dynamically changing a third portion of the electronic document and/or generating a message is executed, where the fourth portion is different from the first portion.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method implemented by an electronic device having a display, comprising:
displaying a first portion of an electronic document having at least two edges without displaying the entire electronic document;
upon receiving input, updating the appearance of the electronic document by displaying a second portion of the electronic document, wherein the second portion is different than the first portion; and
dynamically updating an appearance of a third portion of the electronic document or generating a message when an edge of the electronic document is reached, wherein the third portion is located between the edge and a position indicating point.

2. The method of claim 1, wherein the step of dynamically updating an appearance of the third portion of the electronic document or generating a message comprises dynamically updating a displayed font size of text in the electronic document.

3. The method of claim 1, wherein the step of dynamically updating an appearance of the third portion of the electronic document or generating a message comprises dynamically updating the displayed spacing between text in the electronic document.

4. The method of claim 3, wherein the step of dynamically updating the displayed spacing comprises dynamically updating the displayed spacing between text in the third portion of the electronic document equidistantly.

5. The method of claim 3, wherein the step of dynamically updating the displayed spacing comprises dynamically updating the displayed spacing between text in the third portion of the electronic document non-equidistantly.

6. The method of claim 1, wherein the step of dynamically updating an appearance of the third portion of the electronic document or generating a message comprises dynamically updating the appearance of an icon.

7. The method of claim 6, wherein the step of dynamically updating the appearance of the icon comprises dynamically changing the displayed shape or size of the icon.

8. The method of claim 1, wherein the step of dynamically updating an appearance of the third portion of the electronic document or generating a message comprises dynamically changing a fifth portion of the electronic document, wherein the fifth portion of the electronic document is located between the position indicating point and the edge opposite to the first edge.

9. The method of claim 1, wherein the step of dynamically updating an appearance of the third portion of the electronic document or generating a message comprises displaying text within the third portion of the electronic document to be displayed in a flashing manner.

10. The method of claim 1, wherein the step of dynamically updating an appearance of the third portion of the electronic document or generating a message comprises causing icons within the third portion of the electronic document to be displayed in a flashing manner.

11. The method of claim 1, wherein the step of dynamically updating an appearance of the third portion of the electronic document or generating a message comprises changing the color of icons within the third portion of the electronic document.

12. The method of claim 1, wherein the step of dynamically updating an appearance of the third portion of the electronic document or generating a message comprises changing the color of fonts within the third portion of the electronic document.

13. The method of claim 1, wherein the display comprises a touch screen display.

14. The method of claim 1, wherein the display comprises a non-touch screen display.

15. The method of claim 1, wherein the position indicating point corresponds to a position of a mouse cursor, a finger touching point on the display, a stylus touching point on the display, or a projection point on the display of a pointing device.

16. The method of claim 1, wherein the step of displaying the second portion of the electronic document is continuously performed as the movement is continuously detected, and wherein the step of displaying the second portion of the electronic document is stopped when the edge of the electronic document is reached.

17. The method of claim 1, wherein the message comprises a vibration or sound generated by the electronic device.

18. An electronic device, comprising:
a display component configured to display an electronic document having at least two edges;
at least one processor;
a memory; and
one or more sequences of instructions, which when executed by the at least one processor, cause:
displaying a first portion of the electronic document without displaying the entire electronic document;
upon receiving input, updating the appearance of the electronic document by displaying a second portion of the electronic document, wherein the second portion is different than the first portion; and
dynamically updating an appearance of a third portion of the electronic document or generating a message when an edge of the electronic document is reached, wherein the third portion is located between the edge and a position indicating point.

19. The electronic device of claim 18, wherein the message comprises the electronic device vibrating or generating a sound.

20. The electronic device of claim 18, wherein the display comprises a touch screen display.

21. The electronic device of claim 18, wherein the display comprises a non-touch screen display.

22. The electronic device of claim 18, wherein the step of dynamically updating an appearance of the third portion of the electronic document or generating a message comprises dynamically updating the appearance of a fifth portion of the electronic document, wherein the fifth portion of the electronic document is located between the position indicating point and the edge opposite to the first edge.

23. The electronic device of claim 18, wherein the input corresponds to a user performing a scroll operating on the electronic document.
